(19) United States
(12) Patent Application Publication
(10) Pub. No.: US 2010/0186566 A1
(43) Pub. Date: Jul. 29, 2010

(54) MACHINE FOR CUTTING OUT DESIGNS PRINTED ON A SUBSTRATE IN THE FORM OF A WEB WOUND ON A REEL

(75) Inventors: Didier Dubesset, Villejuif (FR); Eric Vilain, Athis-Mons (FR)

Correspondence Address: YOUNG & THOMPSON, 209 Madison Street, Suite 500, Alexandria, VA, 22314, US

(73) Assignee: GRAFITRONIKS, Vitry sur Seine (FR)

(21) Appl. No.: 12/665,075

(22) PCT Filed: Jun. 17, 2008
(86) PCT No.: PCT/EP08/57617

§ 371 Date: Dec. 17, 2009

(30) Foreign Application Priority Data
Jun. 18, 2007 (FR) 0704295

(51) Int. Cl. B26D 5/20; B26D 7/32; B26D 7/18; B26D 7/01

(52) U.S. Cl. 83/156; 83/436.6; 83/422; 83/436.75; 83/409

(57) ABSTRACT

A machine for cutting out patterns (1) printed on a substrate in the form of a web (2) wound on a reel, extends vertically and has web (2) driving elements using a belt conveyor (13) which runs in a vertically oriented closed loop. This conveyor belt (13) offers an optimized adhesion surface based on the use of its two large lateral faces and is placed between a loading station (5) and an unloading station (7) installed on either sides of the lateral faces of the conveyor belt (13).

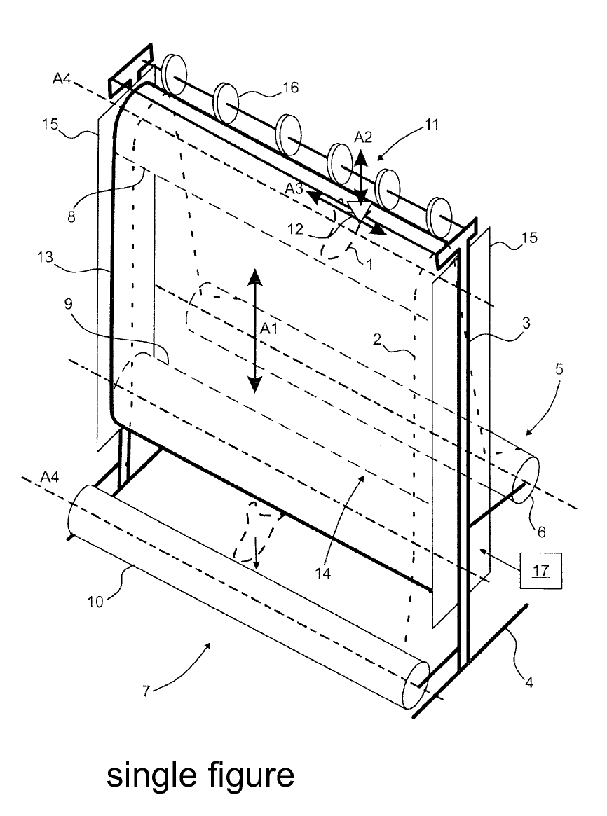

### TECHNICAL FIELD OF THE INVENTION

The invention belongs to the field of the handling of web materials applied to the printing field, and more particularly applied to the machines for cutting out printed patterns on such a material. Its object is a machine for cutting out a printing substrate in the form of a web and conditioned in a roll, which is to organized to separate patterns printed on the substrate on the basis of the travel of the web with respect to a moveable cutting tool.

### TECHNICAL BACKGROUND

In the printing field, it is common to print patterns on a substrate, then to cut out these patterns to separate them from this substrate. It is more particularly known to use a substrate which consists of a sheet or analogue formed as a web and conditioned in a roll. The web, on which the patterns have been previously printed, is driven from an unfolding reel towards a movable cutting tool, with respect to which the web travels in order to separate from the latter the previously printed patterns. For this purpose, cutting machines are known mainly made up of a loading station including the unfolding reel, of an upstream station for routing the web towards a cutting station including the cutting tool and its moving means, and a downstream station for routing the web towards an unloading station where the cut out patterns are recovered and where the remainder of web is discharged. To make it possible for the cutting tool to cut the web, this one circulates at the cutting station between the cutting tool and a counter support member. The web is driven by driving means including at least one rotating driving roller placed at the unloading station and around which the web is rolled up, optionally motorized trains of wheels being placed at longitudinal edges of the web and/or transversely to its travelling direction for its guiding and its positioning between the various stations.

Generally, it is desirable that the cutting machine is structurally as simple as possible and of the lowest possible obstruction for reducing its manufacturing cost and for its easy implementation on site, even also to simplify its use. However, the means implemented to reach a reliable and precise cutting of the patterns might be complex, with the consequence of affecting these structural simplicity, reduced obstruction and ease of use of the machine. It results for the designers in reaching a compromise between these stipulations.

The quality of the positioning and of the driving of the web between the unloading and loading stations must permit a reliable is and precise cut out of the patterns. It is necessary that not only the roller of the web is correctly positioned with respect to the general axis of advance of the web, but also that the conditions of the driving conditions of the web guarantee a position maintaining of the latter along this axis. The modes of correlation and of relative mobility between the web and the cutting tool are also decisive, and it is desirable that the cutting operation is carried out as soon as possible for patterns the contour of which to be cut out that might be geometrically complex. Another difficulty resides in the treatment of the patterns after their separation from the web and their collection at the unloading station.

According to a first approach contributing to a simple structure and of a low obstruction, the machine is organized starting on the basis of a frame of vertical extension. It is common that such a frame is organized as a carriage and that the operating conditions of the machine are reduced to simplify its structure and to limit its obstruction. Such a machine is especially intended to treat a printing substrate of the type made out of cellular material, plastic material or a similar printing substrate, having a thickness of an order inferior to the millimetre. Such a cutting machine currently uses the principle of the “half-flesh” cutting, which consists in partially cutting the web in-depth to permit a holding of the patterns on the web despite of the cutting of their contour. Particularly, the printing substrate is formed of at least two layers including the printed sheet and a substrate for holding the patterns which are joined together by an adhesive film. The cutting operation of the web consists in cutting the sheet by preserving the holding substrate, then to withdraw the patterns from this holding substrate. The unfolding reel and the driving roller are placed respectively at rear and in front of the frame, while the cutting station is placed at the top of the frame. A sacrificial bar placed at the cutting station constitutes the counter support member for the cutting tool. Such a machine has the is advantages to be non expensive and of a reduced obstruction on the ground, and to be able to be easily implemented on site and permitting its easy and quick implementation with simplified adjustment operations, and to limit the extent and the frequency of the maintenance operations. However, these advantages are provided to the detriment of the quality and of the precision of the obtained cutting of the patterns, and even do not permit a cutting of patterns the contour of which is geometrically complex.

According to a second approach contributing to a reliable and precise cutting of the printing substrate, including for a printing substrate of substantial thickness, the machine is organized on the basis of a frame of horizontal extension arranged as a table. Such a machine makes it possible to treat not only one printing substrate of low thickness but nevertheless of a rigidity offering a homogeneous natural behaviour, but also printing substrates capable to be flexible and having a low natural behaviour in their plane, such as the textile ones, and/or thick printing substrates. Such a cutting machine currently uses the principle of “full flesh” cutting, which consists in completely cutting in-depth the web until isolating the patterns from the remainder of web. The table offers a supporting and guiding surface of the web via a sacrificial conveyor belt, which is in a closed loop and which is provided with means of the depression type to make the web adherent to its surface. Such an adhesion makes it possible to hold the web in its general plane at the cutting station, and to hold the cut out patterns until their collection at the unloading station. The web travels on the plate of the table and the cutting tool is capable to move in a plane to parallel to the plate to cut out patterns having a contour which is geometrically complex. Such a machine provides with a holding and an efficient driving of the web in its general plane whatever its weight and/or its thickness, and makes it possible to freely organize the conditions of mobility of the cutting tool to optimize the possibilities offered for the cutting of the web. However, the modalities of operation of the machine induce a substantial obstruction of the table on the ground, and a complexity of the implemented means with, consequently, manufacture and maintenance costs of the machine which are not acceptable for printing substrates of low thickness of the type made out of cellular material, plastic material or similar printing substrates.

### OBJECT OF THE INVENTION

The purpose of the present invention is to propose a machine for cutting out printed patterns on a substrate made of a web conditioned in a roll, which provides for a satisfying compromise between the various constrains which have been mentioned. It is more particularly aimed by the present invention to propose such a cutting machine which is of a simple structure, has a low obstruction on the ground and which has an exploitation easy to implement, and which nevertheless permits to render reliable the precision and the quickness of the cutting of the patterns, including for patterns having a contour the form of which is geometrically complex.

The machine according to the present invention is organized to cut out printed patterns on a substrate in the form of a web conditioned in a roll. This machine is of the kind including a frame of vertical extension provided with a mounting for its rest on the ground. It will be understood that this frame is oriented in order to make the web travelling along a substantially vertical orientation corresponding to the orientation of extension of the machine, even by analogy in a more or less inclined manner. One will note that a desired result for such cutting machines having a vertical extension resides in a reduction of their obstruction on the ground, on the basis of a displacement of the web in a plane which is as near as possible to the vertical. The machine includes, for the routing of the web, driving means of the latter along an axis of advance corresponding to the extension of the web in unfolding. These driving means implement at least a motorized roller arranged transversely with respect to the axis of advance of the web to circulate the web towards a cutting station interposed between a loading station arranged as an unfolding reel of the web and an unloading station for the discharge of the cut out web. The cutting station implements a cutting tool which is movable along two axes of operation comprising a first axis of operation corresponding to the depth of the web for the cutting of the latter and a second axis of operation aligned transversely with respect to the axis of advance. The cutting operation, along a contour assigned to at least one pattern to be cut out, is carried out on the basis of a combination of movements between the movement of the web along the axis of advance and the displacement of the cutting tool along the second axis of operation. One will note a characteristic of these cutting machines of the type with vertical extension in that the cutting tool is operable to follow the contour of the pattern to be cut out along a mono directional trajectory exclusively aligned along an axis parallel with the driving roller, in combination with the travelling displacement of the web at the cutting station along its axis of advance. These provisions aim to propose a machine of simple structure, especially in comparison with the organization of the mobility of the cutting tool, and having a reduced obstruction on the ground.

According to the present invention, a machine of the above mentioned type is mainly recognizable in that that the driving means implement a closed loop conveyor belt, which is provided with means for adhesion of the web on its outer surface. This conveyor belt is in drive with at least one driving roller, being in a closed loop. The closed loop conveyor belt extends interposed between the loading station and the unloading station which are is placed on both sides of the large lateral faces of the frame.

The large lateral faces of the frame are mainly defined by the large lateral faces of the conveyor belt, and the vertical orientation of the frame corresponds to a transverse, and especially vertical or comparable orientation, of its large lateral faces with respect to the rest plane of the frame on the ground. The closing in a loop of the conveyor belt is carried out on the basis of the engagement in drive of the conveyor belt on at least a first driving roller, and on a second roller which is indifferently a second driving roller or a return roller of the belt conveyor which is idly mounted on the frame.

It results from these provisions that the web is held and driven by means of its surface corresponding to the surface of adhesion provided by the conveyor belt, to improve its holding in its general plane in spite of the mono directional antagonistic mobility of the cutting tool along its second axis of mobility. The closing of the conveyor belt in a loop and its orientation in verticality, or comparable, makes it possible to exploit one and the other of its large lateral faces for the holding of the web, with advantage to improve this holding for a vertical extension of the conveyor belt the most reduced as possible.

The limitation of the mono directional mobility of the cutting tool, which simplifies the modalities of use of the machine and which makes it possible to simplify its structure, does not induce inaccuracy of the realized cut out. The web is held by sticking against the outer surface of the conveyor belt, which plays the role, for the cutting tool, of a sacrificial member adapted to authorize a “full flesh” cutting of the web and to forbid the slip and/or a possible crumpling of the latter in spite of the mono directional displacement of the cutting tool transversely to the axis of advance of the web.

The organization of the means for holding and driving the web in a conveyor belt permits to easily arrange such means for holding and driving to be able to practice a cutting of the patterns along a geometric contour of complex form, on the basis of a reciprocating movement conferred on the conveyor belt which makes it possible to move the web alternatively on both sides of the second axis of operation of the cutting tool for the cutting of such a contour.

The conveyor belt preferably constitutes a reciprocating driving member of the with respect to its position at the vertical of the second axis of mobility of the cutting tool. More particularly, the conveyor belt is preferably operable by the driving roller along two opposite directions corresponding to the axis of advance of the web, so that, on the basis of an operation of the driving roller selectively along one or the other one of its directions of rotation, the conveyor belt is alternatively displaced along the said opposite directions.

The driving roller is preferably placed at the cutting station to constitute a counter support member for the cutting tool. It will be understood that the cutting tool moves preferably along its second axis of mobility along a direction parallel with the driving roller, while being slightly shifted with respect to the latter along the axis of advance of the web to avoid wounding of the driving roller. This driving roller is preferably used to constitute a return roller participating to the looping of the conveyor belt.

The means of adhesion might be of a non specified type, such as depression type or electrostatic type for example. In the case of means of adhesion of the depression type, the conveyor belt is for example formed of a porous and/or micro perforated textile, such as containing mixed fibres or analogue, conferring an to ability to air permeability.

In the case of means of adhesion of the electrostatic type, the conveyor belt is in relation with means for power connection, and is for example formed of a plastic material charged with particles to render it conductive.

According to an embodiment, in which the means of adhesion are of the depression type, the conveyor belt is permeable to air and is in air communication with a depression chamber provided by the frame. This depression chamber is preferably delimited between at least two remote return rollers on which the conveyor belt is closed in a loop, and a couple of end flanges which are constituent of the frame and on which the return rollers are rotatably mounted.

The return rollers preferably comprise a first driving roller permitting a through passage of the depression, and at least a second roller indifferently made up of a driving roller or of a free rotating guiding roller. The closing in a loop of the belt is preferably arranged in two large substantially parallel lateral faces, to limit the lateral obstruction of the machine.

More particularly, the first return roller is placed at the top of the frame while being overhung by the cutting station; the second return roller is impermeable to air to prohibit the passage of the depression, and arranged at the base of the frame in the vicinity of which the unloading station is placed. The lateral obstruction of the machine is limited with a dimension about the diameter of the largest return roller. The cut out patterns in “full flesh” are maintained by the conveyor belt in spite of their separation of the web, and are spontaneously removed of the latter at the unloading station due to their natural fall caused by the absence of adhesion of the conveyor belt in the zone of the second return roller impermeable to air.

More particularly, the second roller is placed at the unloading station and is impermeable to air to constitute a separation member of the patterns with respect to the web, due to their natural fall at the unloading station.

The unloading station is preferably equipped with a roller for collecting of the remainder of web. This collecting roller is laid out downstream of the impermeable roller, in the travelling direction of the web, between the loading station and the unloading station, and preferably of a container or analogue for the collection of the patterns consecutively to their spontaneous fall. One will note that the collecting roller is especially a motorized roller, the rotation of which is controlled in correspondence with the rotation of the driving roller, while being circumstantially equipped with means for maintaining the web under tension to compensate for the possible variations of the diameter resulting from the progressive rolling up of the remainder of web around the collecting roller.

The cutting station is optionally equipped with a train of wheels for pressing the web against the conveyor belt against the support that the latter takes against a counter support member.

This counter member support is particularly made of the first return roller.

### DESCRIPTION OF THE FIGURE

The present invention will be better understood when reading the description of which that will be made in relation to the single FIGURE of the annexed drawing sheet, which schematically illustrates, in perspective, a cutting machine according to an example of realization of the present invention.

On the FIGURE, a machine is intended to cut out patterns 1 in full flesh in a web 2 constituting a printing substrate for these patterns 1.

This cutting machine comprises a frame 3 vertically oriented and provided at its base with a mounting 4 for resting on the ground. The frame 3 carries, in a manner movable in rotation to around horizontal axes, various rollers 8, 9 which are intended to guide and/or drive the web 2 during its unfolding between a loading station 5 arranged as an unfolding reel 6, and an unloading station 7.

These unloading 7 and loading 5 stations are arranged on is both sides of the large vertical lateral faces of the frame 3, and at the latter, i.e. close to the mounting 4.

The rollers 8, 9 are oriented transversely with respect to the A1 vertical axis of advance of the web in unfolding between the loading station 5 and the unloading station 7, the latter being provided with a collecting roller 10 for the remainder of web 2 after separation of patterns 1. The axis A1 of unfolding is orthogonal with the horizontal axes A4 of the rollers.

A cutting station 11 is arranged at the top of the frame 3 and is provided with a cutting tool 12 which is operable along a first axis of mobility A2 towards the web 2 for its cutting. The cutting of the patterns 1 is carried out on the basis of a combination of movements between the displacement of the web 2 along its axis of advance A1 and an operation of the cutting tool 12 along a second horizontal axis A3 of mobility which is oriented transversely with respect to the axis of advance A1 of the web 2 and parallel to the axes of extension A4 of rollers 8, 9.

The holding and the driving of web 2 along its axis of advance A1 are carried out via a conveyor belt 13 which is in closed in loop around itself via a couple of return rollers 8, 9. A first return roller is placed at the top of the machine and constitutes a motorized drive roller 8 for the conveyor belt 13 along the axis A1 of advance of the web 2. This first return roller 8 is placed in relationship to the cutting tool 12 to constitute a counter support member for the latter during the cutting operation.

The first return roller 8 is a driving roller which can be driven in rotation around itself along the two directions, to permit a drive of the conveyor belt 13 and thus of the web 2 along one to and the other one of the two opposite directions, corresponding to the axis of advance A1 of the web 2. This mobility with two opposite directions of advance of the conveyor belt 13 makes it possible to move the web 2 according to a reciprocating movement at the vertical of the cutting tool 12, to permit a cutting of the patterns 1, the contour of which that is to be cut out that is assigned thereto might present a complex geometric form.

The second return roller 9 is a guiding roller for the conveyor belt 13, which is idly mounted in rotation on the frame 3 and which is placed at the base of the machine, in the zone of the unloading station 7.

The outer surface of the conveyor belt 13 is made adherent for the holding by sticking of the web 2 thanks to its design permeable to air and to its bringing in relation to the means of depression (not illustrated in details). This putting under depression is obtained on the basis of putting under vacuum of a depression chamber 14 arranged in the frame 3.

Vacuum generating means 17 are put in communication with the depression chamber 14, either by being placed inside the latter or by being placed outside of the depression chamber 14 and being in air communication with this one, such as schematically illustrated. The depression chamber 14 is delimited between the two large lateral faces of the conveyor belt 13, by the driving roller 8 which is permeable to air for the passage of the depression through the conveyor belt and by the second return roller 9 in closing of the conveyor belt 13. End flanges 15 supported by the frame 3 are placed at the ends of the rollers 8, 9 to confine the inner volume of the depression chamber 14.

The second return roller 9 is tight to the air to prohibit a passage therethrough of the depression produced inside the depression chamber 14, and thus a passage of the depression through the conveyor belt 13 in the zone of the unloading station.

These provisions are such that pieces corresponding to the to patterns 1 cut out and maintained stuck against the belt between the cutting station 11 and unloading station 7, are spontaneously removed from the web 2 on the basis of their natural fall, because of the absence of depression through the conveyor belt 13 in its driving zone on the second return roller.

At the unloading station, the remainder of the web 2 is recovered by the collecting roller 10, while patterns 1 are capable to be collected by an operator or to be recovered inside a container or analogue.

At the cutting station 11, the machine comprises a pressing train 16 of wheels, to improve the sticking of the web 2 against the conveyor belt 13 in the zone of mobility of the cutting tool 12 along its second axis of mobility A3.

In addition, various return rollers for the web 2 can be installed to guide the unfolding of the latter between the loading station 5 and unloading station 7, and especially to bring the web 2 in contact against the conveyor belt a 13 along an optimized surface of adhesion.

The closing in a loop of the conveyor belt 13 is preferably carried out so as to form a profile having two parallel large vertical lateral faces, to reduce the lateral obstruction of the machine to a dimension about the diameter of the largest return roller 8, 9. It is however possible that this closing in a loop of the conveyor belt 13 is carried out according to a non specified profile.

1. Machine for cutting cut out patterns (1) printed on a substrate in the form of a web (2) conditioned in a roll, this machine comprising a frame (3) of vertical extension and means for the driving of the web (2) along an axis of advance (A1) corresponding to the extension in unfolding of the web (2), these driving means implementing at least one motorized roller (8, 9) arranged transversely with respect to the axis of advance (A1) to circulate the web (2) towards a cutting station (11) interposed between a loading station (5) arranged as an unfolding reel (6) of the web (2) and an unloading station (7) for the discharge of the cut out web (2), the cutting station (11) implementing a cutting tool (12) which is movable along two axes of operation (A2, A3) comprising a first axis of operation (A2) corresponding to the depth of the web (2) for the cutting of the latter and a second axis of operation (A3) aligned transversely with respect to the axis of advance (A1), the cutting operation, along a contour assigned to at least one pattern (1) to be cut out, being carried out from a combination of movements between the movement of the web (2) along the axis of advance (A1) and the displacement of the cutting tool (12) along the second axis of operation (A2), characterized in that the driving means implement a closed loop conveyor belt (13), which is provided with means for adhesion of the web (2) on its outer surface and which is in drive with at least one driving roller (8, 9), this closed loop conveyor belt (13) extending between the loading station (5) and the unloading station (7) which are placed on both sides of the large lateral faces of the frame (3).

2. Cutting machine according to claim 1, characterized in that the conveyor belt (13) is operable by the driving roller (8, 9) along the two opposite directions corresponding to the axis of advance (A1) of the web (2), so that, on the basis of an operation of the driving roller (8, 9) selectively along one or the other of its senses of rotation, the conveyor belt (13) is alternatively displaced along the aforementioned opposite directions.

3. Cutting machine according to claim 1, characterized in that the driving roller (8) is placed at the cutting station (11) and constitutes a counter cutting member for the cutting tool (12).

4. Cutting machine according to claim 1, characterized in that the means for adhesion of the web are indifferently of the depression type or of the electrostatic type.

5. Cutting machine according to claim 1, characterized in that the means for adhesion of the web being of the depression type, the conveyor belt (13) is permeable to air and is in air communication with a depression chamber (14) provided by the frame (3).

6. Cutting machine according to claim 5, characterized in that the depression chamber (14) is delimited between at least two remote return rollers (8, 9) on which the conveyor belt (13) is closed in a loop, and a couple of end flanges (15) which are constituent of the frame (3) and on which the return rollers (8, 9) are rotatably mounted.

7. Cutting machine according to claim 5, characterized in that the return rollers (8, 9) comprise a first driving roller (8) permitting a through passage of the depression, and at least a second roller (9) indifferently made up of a driving roller or of a free rotating guiding roller.

8. Cutting machine according to claim 7, characterized in that the second roller (9) is placed at the unloading station (7) and is impermeable to air to constitute a separation member of the patterns (1) with respect to the web (2) due to their natural drop at the unloading station (7).

9. Cutting machine according to claim 8, characterized in that the unloading station (7) is equipped with a roller for collecting (10) of the remainder of the web (2) laid out downstream of the impermeable roller (9).

10. Cutting machine according to claim 1, characterized in that the cutting station (11) is equipped with a train of wheels (16) for pressing the web (2) against the conveyor belt (13) against the support that the latter takes against a counter support member.

11. Cutting machine according to claim 2, characterized in that the driving roller (8) is placed at the cutting station (11) and constitutes a counter cutting member for the cutting tool (12).

12. Cutting machine according to claim 2, characterized in that the means for adhesion of the web are indifferently of the depression type or of the electrostatic type.

13. Cutting machine according to claim 2, characterized in that the means for adhesion of the web being of the depression type, the conveyor belt (13) is permeable to air and is in air communication with a depression chamber (14) provided by the frame (3).
